(19) United States
(12) Patent Application Publication
(10) Pub. No.: US 2012/0077029 A1
(43) Pub. Date: Mar. 29, 2012

(54) Plastic Laminate and Non-Stick Lid Constructed of Plastic Laminate

(75) Inventors: Randall Troutman, Kenosha, WI (US); Lawrence P. Seibel, Kenosha, WI (US); Donald S. Strickland, Antioch, IL (US)

(73) Assignee: LMI Packaging Solutions, Inc., Pleasant Prairie, WI (US)

(21) Appl. No.: 13/241,631

(22) Filed: Sep. 23, 2011

Related U.S. Application Data
(60) Provisional application No. 61/387,559, filed on Sep. 29, 2010.

(51) Int. Cl. B32B 7/12; B65B 7/28; B29C 65/48; B65D 51/00; B65D 17/34

(52) U.S. Cl. 428/352; 220/212; 220/270; 427/207.1; 156/69

(57) ABSTRACT

A device for closing a food container that includes a barrier substrate that sufficiently inhibits oxygen and moisture transfer therethrough and that has a portion of a first major surface coated with a functional layer that comprises a thermoplastic adhesive and a release agent. The release agent operational such that the lid is incompatible at least with conventional shrink wrap film (LDPE) during a conventional heat shrinking process.

### CROSS-REFERENCE TO RELATED APPLICATION

The benefit of priority of U.S. Provisional Application No. 61/387,559, filed Sep. 29, 2010, is hereby claimed and the entire contents thereof are incorporated herein by reference.

### FIELD OF DISCLOSURE

This disclosure generally relates to a material, article, and method for closing a food container, for example, a food container containing yogurt.

### BACKGROUND

Individual portioned food products are often provided with a removable lid adhered to a packaging or food container. Each lid prevents the contamination and/or spoilage of the food product by hermetically sealing the food product inside the package. Conventionally, these lids have been constructed from metal based foils. More recently, however, a demand for plastic lids has risen due to heightened cost concerns and the increased demand for metal detection in sealed food containers.

Once sealed, the individually portioned food products are often sorted by wrapping large numbers of the individually portioned food products on pallets or carts. Often the wrapping is improved by heat shrinking the wrapping to the products on the pallets or carts. Unintentionally, the heat shrinking of the wrapping causes the wrapping to bind or otherwise adhere to tab portions of the seals or lids, which can result in the disruption of the hermetic seal upon removal of the heat shrink wrapping. This loss of the hermetic seal precludes the storage and sale of the food product and therefore results in an economic loss.

### SUMMARY

In one embodiment, a plastic laminate includes a barrier substrate that has a portion of a first major surface coated with a functional layer that comprises a thermoplastic adhesive and a release agent.

In another embodiment, the plastic laminate is manufactured by binding the functional layer to the barrier substrate.

In still another embodiment, a food container lid includes the plastic laminate.

In yet another embodiment, a food container can be closed by binding the plastic laminate, e.g., the food container lid, to a rim of the food container.

In another embodiment, a sealed food container includes a food product, a food container, and a plastic laminate adhered to and closing the plastic container.

### BRIEF DESCRIPTION OF THE DRAWING FIGURES

For a more complete understanding of the disclosure, reference should be made to the following detailed description and accompanying drawings wherein:

FIG. 1 is a drawing of a food container with a food container lid partially pulled off of the food container;

FIG. 2 is a partial cross-sectional drawing of a food container displaying the point of contact between the rim of the food container and the lid;

FIG. 3 is a profile view of a food container lid showing the body portion and the tab portion of the lid;

FIG. 4 is a cross-sectional side view of one alternative embodiment of a lid constructed in accordance with the principles of the present disclosure;

FIG. 5 is a cross-sectional side view of another alternative embodiment of a lid constructed in accordance with the principles of the present disclosure; and

FIG. 6 is a cross-sectional side view of yet another alternative embodiment of a lid constructed in accordance with the principles of the present disclosure.

While the disclosed articles and methods are susceptible of embodiments in various forms, there are illustrated in the drawings (and will hereafter be described) specific illustrative embodiments of the invention, and these drawings are not intended to limit the invention to the specific embodiments described and illustrated herein.

### DETAILED DESCRIPTION

Herein is provided a material and method for hermetically sealing food containers that are not disrupted by wrapping with heat shrink films (e.g., LDPE) and later removal of the heat shrink film. The material includes a plastic laminate for sealing the food container and which forms a hermetic seal between the laminate and the container.

The articles and methods described herein may be understood more readily by reference to the following detailed description and the examples provided. It is to be understood that this invention is not limited to the specific components, articles, processes and/or conditions described, as these may, of course, vary. It is also to be understood that the terminology used herein is for the purpose of describing particular embodiments only and is not intended to be limiting.

Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

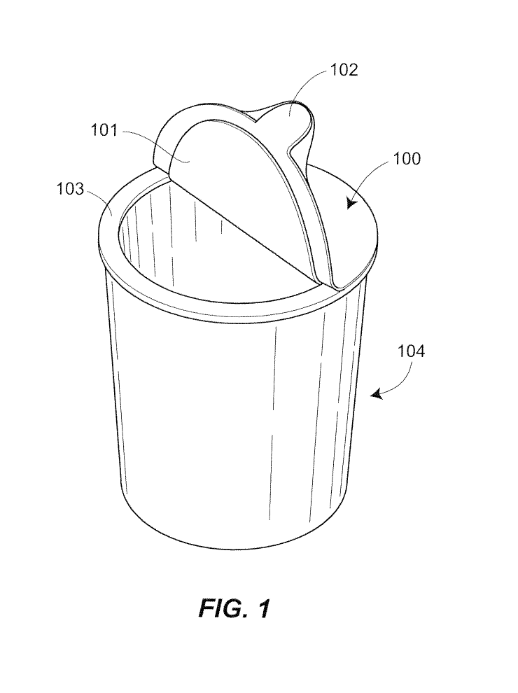

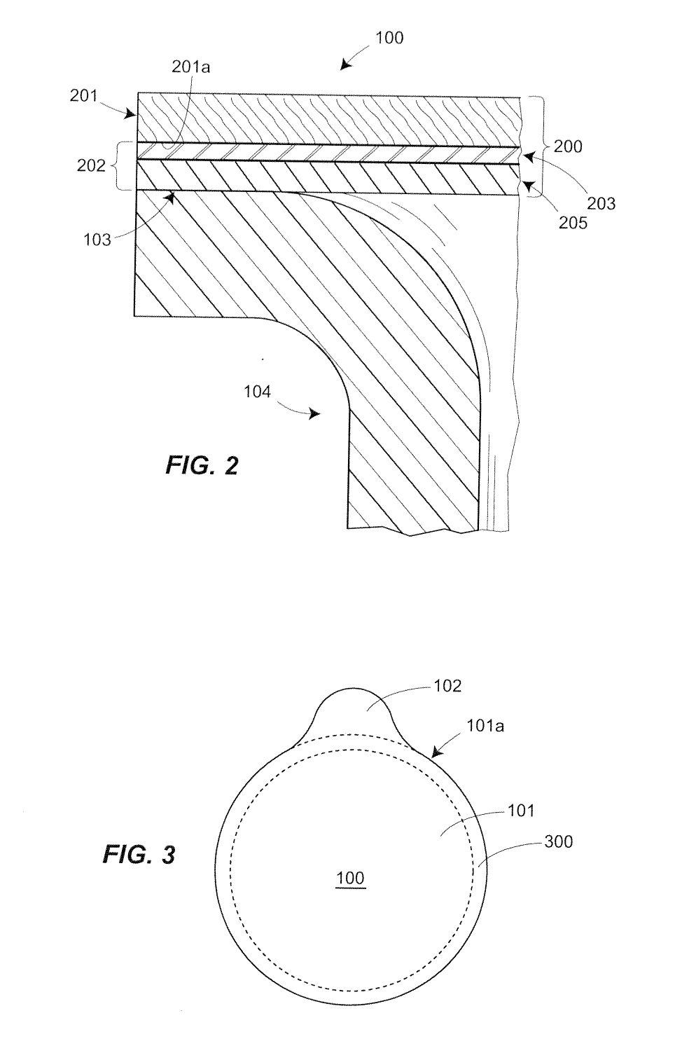

FIGS. 1-3 depict one embodiment of the present disclosure including a lid 100 and a container 104. The container 104 can include a generally cylindrical container adapted to contain a food product such as yogurt, cheese, etc. As shown in FIG. 2, in one embodiment, the lid 100 is constructed as a plastic laminate 200 having a barrier substrate 201 that sufficiently inhibits oxygen and moisture transfer therethrough and that has at least a portion of a first major surface 201a coated with a functional layer 202. The functional layer 202 can comprise, amongst other things, a thermoplastic adhesive and a release agent. Sufficiently inhibiting oxygen and moisture transfer means an oxygen permeability of less than about 5 mL, less than about 4 mL, less than about 3 mL, or less than about 2 mL per 100 in² over 24 hours at 22° C. and 50% relative humidity, and a water vapor permeability of less than about 1.2 g, less than about 1.1 g, less than about 1 g, less than about 0.9 g, less than about 0.8 g, less than about 0.7, or less than about 0.6 g per 100 in² over 24 hours at 38° C. and 90% relative humidity.

As shown in FIG. 2, the functional layer 202 can include at least two layers, for example, an adhesive layer 203 that comprises the thermoplastic adhesive and a release layer 205 that comprises the release agent. The two layers 203, 205 can be coextensive on the surface of the barrier substrate 201 or the release layer 205 can coat a portion of a surface of the thermoplastic adhesive layer 203. For example, the first major surface 201a of the barrier substrate 201 can be coated with the adhesive layer 203 and at least a portion of the adhesive layer 203 can be coated with the release layer 205. As such, the barrier substrate 201 coated with the thermoplastic adhesive layer 203 can include an area not coated with the release layer, i.e., an incomplete coating.

As shown in FIG. 3, one embodiment of the plastic laminate 200 includes a sealing portion 101 and a tab portion 102 extending from a perimeter edge 101a of the sealing portion 101. The sealing portion 101 can be, for example, free of or substantially free of the release agent. For example, in one embodiment, the release agent is disposed only on the tab portion 102 of the laminate 100, adjacent the major surface 201a of the barrier substrate 201.

In some embodiments, the release agent or layer 205 can be disposed on the tab portion 102 and on a portion of the sealing portion 101 adjacent to the tab portion 102. This arrangement of the release agent or layer 205 can result from the process by which the adhesive and/or release agents are applied to the barrier substrate 201. For example, in one embodiment, the release layer 205 can be applied to the adhesive layer 203 using a flexographic printing process that generally prints bands or stripes on a sheet of the barrier substrate 201, for example, after the adhesive layer 203 has been applied. The bands or stripes of release layer 205 can have, for example, substantially uniform widths and can be, for example, substantially linear. Bands or stripes of release layer 205 having non-uniform widths and non-linear configurations are also contemplated. For example, in various embodiments, the bands or stripes can have non-uniform widths and/or can be non-linear, for example, to substantially correspond to the shape of the tab portion 102 and reduce and/or eliminate overlapping of the release layer 205 onto the sealing portion 101.

After the release layer 205 is printed onto the adhesive layer 203, a plurality of lids 101 can then be cut, for example, die cut, out of the sheet. For example, the lids can be cut such that the tab portions 102 of the lids 100 correspond to the portions of the sheet having the bands or stripes of release layer 205 printed thereon. In embodiments where the bands or stripes have generally uniform widths, the release layer 205 typically overlaps with the sealing portion 101 of the lid 100, adjacent to the tab portion 102.

In yet another embodiment, the thermoplastic adhesive or adhesive layer 203 can be confined to only the contact portion 300 of the sealing portion 101 such as to form a ring for sealing to a container as will be described in detail below.

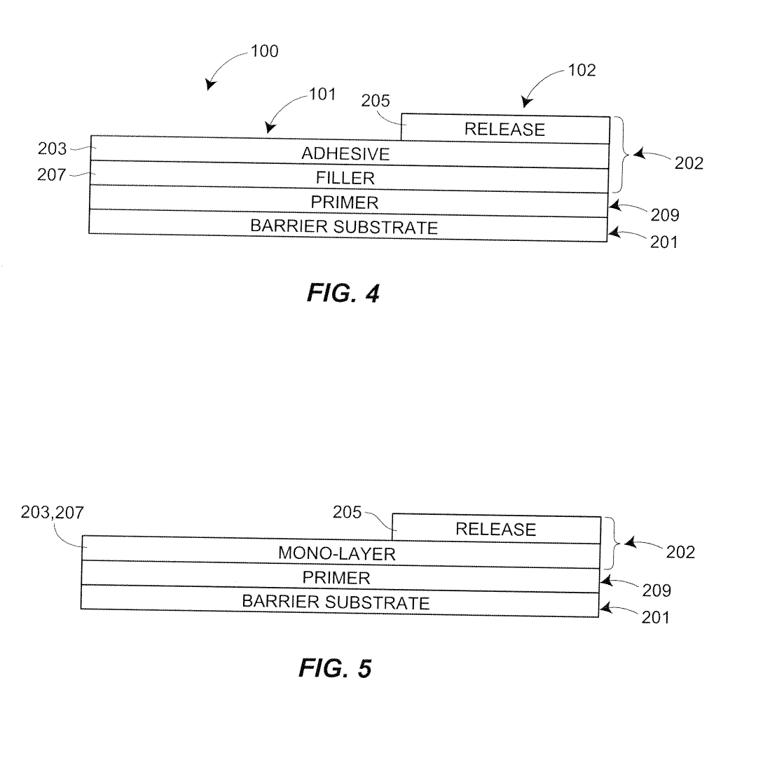

FIG. 2 illustrates the functional layer 202 having two layers 203, 205 bonded directly to the major surface 201a of the barrier substrate 201. The functional layer 202 may include any suitable number of layers. For example, FIG. 4 depicts a cross-sectional schematic representation of one alternative embodiment of a plastic laminate constructed as a lid 100 including a barrier substrate 201, a functional layer 202, and a primer 209 disposed or sandwiched between the barrier substrate 201 and the functional layer 202. The barrier substrate 201 can be constructed in accordance with any of the barrier substrates 201 discussed herein throughout. The primer 209 can be incorporated to ensure a robust bond between the functional layer 202 and the barrier substrate 201, and to maintain the integrity of this bond by promoting a resistance to the packaged food product, and/or for any other foreseeable objective.

Additionally, as shown in FIG. 4, the functional layer 202 can also include a filler layer 207. The filler layer 207 can include a layer of high-density polyethylene (HDPE), for example. The filler can also include a pigment to provide the lid 100 with a desired color. Additionally, the filler layer 207 can include other components to achieve other objectives, and is only herein referred to as a filler layer 207 for the sake of description.

Referring to FIG. 4, the release layer 205 of the functional layer 202 is can be less than co-extensive with the adhesive layer 203 and the remainder of the lid 100. In the embodiment illustrated in FIG. 4, the release layer 205 is disposed or deposited only on the tab potion 102 of the lid 100. In various other embodiments, the release layer 205 can be disposed over the entire lid 100, and be coextensive with the remainder of the functional layer 202 and the barrier substrate 201.

The functional layer 202 can include individual layers—i.e., the filler layer 207, the adhesive layer 203, and the release layer 205—as shown in FIG. 4. Alternatively, these individual layers can be provided as components of one or more co-extruded materials that function as the described layers. An example of this can be seen in FIG. 5, which illustrates a lid 100 having a functional layer 202 that has a mono-layer 203, 207 and release layer 205. The lid of FIG. 5 can otherwise be identical to the lid 100 described above with reference, for example, to FIG. 4. The mono-layer 203, 207 can include, for example, a co-extruded admixture of thermoplastic adhesive material and a high-density polyethylene carrying a pigment, for example, or other component represented by the filler layer 207 in FIG. 4. Utilizing co-extruded admixtures in this manner can, in some instances, reduce costs and manufacturing times.

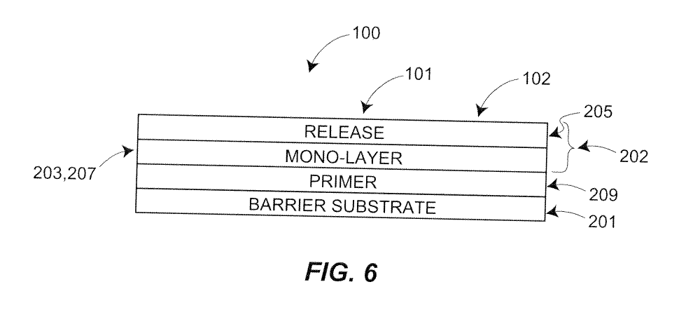

In various embodiments, the functional layer 202 can include, for example, an admixture of co-extruded components of the lid 100. For example, as can be seen in FIG. 6, the entire surface area of the lid 100 including the sealing portion 101 and the tab portion 102 can have the same functional layer 202. While FIG. 6 illustrates a lid 100 with a functional layer 202 constructed similar to that of FIG. 5 (i.e., with a mono layer and a release layer), it could alternatively be constructed similar to that of FIG. 4 (i.e., with a filler layer 207, an adhesive layer 203, and the release layer 205).

The lid 100 can include, for example, the release agent or layer 205 disposed adjacent to the adhesive agent or layer 203 and is not in direct contact with the barrier substrate 201. Alternatively, the barrier substrate 201 can be coated with a thermoplastic adhesive and a release agent such that the thermoplastic adhesive coats only the sealing portion 101 of the barrier substrate 201 and the release agent is disposed directly on the barrier substrate 201, coating only the tab portion 102. Yet further, in another alternative, the barrier substrate 201 can be coated with a thermoplastic adhesive such that the thermoplastic adhesive coats only the sealing portion 101 of the barrier substrate 201 and the barrier substrate 201 can be exposed in the tab portion 102 as the barrier substrate 201 may be incompatible with shrink wrap film.

In addition to the materials described above, the plastic laminate 200 of the present disclosure can further include any one or more materials safe for contact with food products, for example, materials permissible for use by the U.S. Food and Drug Administration (FDA) under 21 C.F.R. §175(C) “Substances for use and components of coatings”; 21 C.F.R. §177(B) “Substances for use and basic components of single and repeated use food contact surfaces”; 21 C.F.R. §177(C) “Substances for use only as components of articles intended for repeated use” the contents of which are incorporated herein by reference to those materials.

The barrier substrate 201 can have a thickness in a range of about 0.0025 mm to about 0.125 mm, about 0.005 mm to about 0.1 mm, about 0.01 mm to about 0.09 mm, about 0.02 mm to about 0.08 mm, and/or about 0.03 mm to about 0.07 mm. For example, the barrier substrate 201 can have a thickness in a range of about 0.0127 mm to about 0.076 mm (e.g., a range of about 0.5 mils to about 3 mils). Other suitable thicknesses include, but are not limited to, about 0.0025 mm, 0.005 mm, 0.0075 mm, 0.01 mm, 0.02 mm, 0.03 mm, 0.04 mm, 0.05 mm, 0.06 mm, 0.7 mm, 0.08 mm, 0.09 mm, 0.1 mm, and 0.125 mm.

The barrier substrate 201 can include a polymer, for example, selected from polyethylene terephthalate, polypropylene, polystyrene, polyester, foil, and a mixture thereof. In one embodiment, the barrier substrate 201 includes polyethylene terephthalate. In another embodiment the barrier substrate 201 consists essentially of polyethylene terephthalate. Herein, a barrier substrate 201 that consists essentially of polyethylene terephthalate means the barrier substrate 201 may include other materials that do not materially and adversely affect the characteristics of the polyethylene terephthalate as a barrier substrate 201. These other materials can include, for examples, primers, dyes, release agents, inks, coatings, pigments, inorganic lubricants, waxes and/or antiblocking agents.

The thermoplastic adhesive of the functional layer 202 can be, for example, a material selected from polyvinyl acetate (PVA), polyvinyl alcohol (PVA), polyacrylate (e.g., Poly(methyl methacrylate) (PMMA)), polyester acrylic resin, silicone resin, polyamine, and a mixture thereof. In one embodiment, the thermoplastic adhesive includes a polyethylmethacrylate and a high density polyethylene (HDPE). For example, the thermoplastic adhesive can be formed of distinct layers of the polyethylmethacrylate and HDPE or can be a coextrusion of the polyethylmethacrylate and HDPE. The thermoplastic adhesive can include the materials permissible for use by the FDA under 21 C.F.R. §175(B) “Substances for use only as components of adhesives”; 21 C.F.R. §175.300 “Indirect Food Additives: Adhesives and Components of Food”; and/or 21 C.F.R. §177.1520 “Indirect Food Additives: Olefin Polymers” the contents of which are incorporated herein by reference to those materials.

The thermoplastic adhesive is capable of sealing the plastic container 104 without significantly damaging the container 104 or the barrier substrate 201. Thermoplastic adhesives often require heating to a temperature above which the thermoplastic adhesive softens, e.g., the glass-transition temperature and/or the Vicat softening point (ASTM D1525) for the thermoplastic. Suitable thermoplastic adhesives for use in the present disclosure include those thermoplastic having a glass-transition temperature less than about 200° C., less than about 190° C., less than about 175° C., less than about 150° C., less than about 125° C., less than about 100° C., less than about 75° C., less than about 50° C., less than about 25° C., and less than about 0° C. may be suitable For example, LDPE can be used as the thermoplastic adhesive and has a glass transition temperature of approximately −78° C. or lower. Suitable thermoplastic adhesives for use in the present disclosure can also or alternatively having a Vicat softening point of less than about 200° C., less than about 175° C., less than about 150° C., less than about 125° C., or less than about 100° C. In other embodiments, thermoplastic adhesives having different glass-transition temperatures may be suitable.

The release agent can include, for example, a high temperature wax, including a wax having a melting point above about 150° C., above about 200° C., above about 250° C., or above about 300° C., The release agent can include, for example, a silicone, an organopolysiloxane, a silicone and siloxane copolymer, and a silicone and siloxane blend. Examples of silicone and siloxane copolymers and blends include, for example, mixtures of an organosiloxane and vinyl methyl ether-maleic anhydride copolymer, epoxypolysiloxane, polysiloxane titanate, and a polyurethane organosilicone blend. The release agent can include, for example, long chain branched polymers, including, for example, alkyacrylate-acrylic acid copolymer, stearyl methylacrylate-acrylonitrile copolymer, polypropylene copolymer, polystyrene copolymer, and strearic acid polyester-fomaldehyde resin. The release agent can include, for example, fluorocarbon polymers, such as perfluoronated polyesters, and perfluoroalkylacryaltes. The release agent can include any combination of the above-mentioned materials and can further include other components which meet the requirements of being incompatible with the shrink film, compatible with the adhesive, and, importantly, meet food regulatory requirements. One example of a material that can be used as the release agent is commercially available as MGS955 (Midwest Graphic Sales, Inc., IL).

As mentioned, the plastic laminate 200 can be for closing a food container 104 as shown in FIG. 1 and, as such, can act as a food container lid 100. The laminate 201 can be made by binding the functional layer 202 to the barrier substrate 201 as depicted in FIG. 2, for example. The plastic laminate 200 can also be made by binding the functional layer 202 to the barrier substrate 201 by applying a thermoplastic adhesive to the barrier substrate 201 and then applying a release agent to the thermoplastic adhesive.

Methods of applying the functional layer to the barrier substrate 201 include, for example, thermal lamination, adhesive lamination, solvent welding, extrusion coating, extrusion laminating, heat seal coating, roller coating, painting, spraying, and other known methods of forming, coating, and/or laminating films or sheets. The functional layer can be applied to the barrier substrate 201 uniformly. A method for forming uniform layers can include impregnation units, knife coating units, wire wound coating bars, roll coaters, spray coaters, size presses, nip presses, and the like. For example, the functional layer can be applied to the barrier substrate, for example, a corona treated barrier substrate, as an emulsion or solution at a coat weight of about 1 to about 1.5 lbs/ream (wherein a ream includes approximately 432,000 in²) and/or about 1.5 to about 4.0 grams per square meter. The coated barrier substrate can then be dried using standard IR and/or hot air driers.

As discussed above, the food container lid 100 of the disclosure, for example, can be cut from a larger sheet of the plastic laminate, and can have a symmetrically shaped body portion 101 and a tab portion 102 extending outwardly from a perimeter edge 101a of the body portion 101. The tab portion 102 is for grasping by a user for removal of the lid, as seen in FIG. 1. The two portions of the food container lid 100, the body portion 101 and the tab portion 102, can combine to form a tear-drop shape (see FIG. 3), an elliptical shape, or a similar shape sufficient to cover a food container and leave an outwardly extending tab for grasping by a user for removal of the lid, as seen in FIG. 1. Herein, at least the tab portion 102 of the food container lid is coated with the release agent (and optionally the adhesive as well), as described above. The body portion 101 can be coated with the release agent or, alternatively, the body portion 101 is substantially free of the release agent.

The food container 104 shown in FIG. 1 can be closed, forming a sealed food container, by a method that includes binding or otherwise attaching or fixing the plastic laminate 200 to a rim 103 of the food container 104 such that the tab portion 102 of the plastic laminate 200 extends from the rim 103 and can function as a plastic laminate removal tab. Generally, one method of closing the food container can include positioning the plastic laminate 200 adjacent to the rim of the food container 104 sufficient to cover an opening in the food container 104. The method, which can include conduction heat sealing, for example, can further include applying a compressive force (pressure) to the plastic laminate 200. In some embodiments, the force can be in a range of about 50 lbs/in² to about 500 lbs/in², in a range of about 110 lbs/in² to about 400 lbs/in², and in a range of about 170 lbs/in² to about 300 lbs/in². For example, the force can be about 250 lbs/in². Notably, the sealing pressure can vary depending on the surface area of the rim 103 and the dwell time at the sealing temperature. The seal between the food container 104 and the lid/plastic laminate is facilitated by applying heat to the plastic laminate 200 sufficient to cause at least a portion of the thermoplastic adhesive of the functional layer 202 to soften. The plastic laminate 200 can be heated to about 350, about 375, about 400, about 425 or about 450° F. In embodiments where the functional layer 202 in the region of the rim 103 of the container 104 includes the thermoplastic adhesive layer 203 sandwiched between the barrier substrate 201 and the release layer 205 (as shown in FIG. 2), the release layer 205 can be displaced from an area defined by the rim 103 by the heating and by the application of the compressive force. As such, the rim 103 of the container 104 can penetrate, extend through, or otherwise pass beyond the release layer 205 to contact the thermoplastic adhesive layer 203 and bind, attach, or otherwise affix thereto in a suitable manner. In one example, the release agent can be compatible (e.g., bind to) with the cup and incompatible with the shrink film, thereby providing an embodiment wherein the release layer can be continuous across the lid and where the release agent functions cooperatively with the adhesive layer in a manner that does not require the rim 103 of the container to seal through or penetrate the release layer to affect the seal.

As discussed above, sealed food containers are often aggregated and secured by wrapping large numbers (e.g., equal to or greater than 6, 12, 24, 48, 96, or 192; typically 6 or 12) of the sealed food containers with a heat shrinkable wrapping and once secured, a high temperature is applied to the wrapping which shrinks and binds the sealed food containers to form a bundle of sealed food containers. For example, a pallet including the secured, sealed food containers can be passed through a processing oven so the wrapping is exposed to a temperature greater than, for example, 300° F., 350° F., 375° F., and/or 400° F., for a time less than about 30 sec, about 15 sec, about 7 sec, and/or about 6 sec. With conventional food container lids, the heat shrinking can activate or soften the thermoplastic adhesive disposed on the tab portion 102 of the lids 100, thereby causing the shrink wrapping to adhere to the food container lid. In circumstances where the wrapping adheres to the food container lid, the removal of the wrapping, for example for display or sale, can result in at least partial removal of the lid from the container and disruption in the hermetic seal between the lid and the food container. Such a disruption can preclude the sale of the food product, thereby resulting in lost profits. To overcome this problem with conventional lids, the present disclosure advantageously includes the presence of the release agent, which reduces or retards the adhesion of the shrink wrapping to the adhesive disposed on the food container lid. Specifically, the release agent effectively makes the functional layer 202 carried by the tab portion 202 of the lid 100 incompatible with the shrink wrapping, thereby reducing and/or eliminating the occurrence of 11d disruption and lost product associated with conventional lids.

While the disclosure has thus far described the lid 100 as being constructed primarily of a polymer, in alternative embodiments, the lid may be formed from a different material that may be a biodegradable material, such as molded fiber or pulp or paper. For example, the lids may be 100% post consumer fiber or pulp feedstock. In another example, the lids may be 100% recycled corrugated fiberboard and newspaper. The materials described herein can include, for example, virgin pulp fiber and can include type-2 molded fiber, type-2A thermoformed fiber, type-3 thermoformed fiber, type-4 thermoformed fiber, molded fiber, X-RAY formed fiber, infrared formed fiber, microwave formed fiber, vacuum formed fiber, structural fiber, sheet stock, recycled plastic or any other structural material (e.g., foil). Any of the materials that may be used to form the lid 100 may be used in any of the embodiments described herein.

Additionally, in some embodiments, the lids 100 may include an accelerator that helps promote degradation after use. Alternatively or additionally, additives can be included which help breakdown the intended content of the lids. For example, where the container is to carry oil, an additive can be included in the lid which helps breakdown oil over time, increasing the recyclable properties of the container. In some embodiments, the lid is made from materials that can be recycled, either completely or in part.

The foregoing description is given for clearness of understanding only, and no unnecessary limitations should be understood therefrom, as modifications within the scope of the invention may be apparent to those having ordinary skill in the art.

1. A plastic laminate comprising:
a barrier substrate having an oxygen permeability of less than about 5 mL over 24 hours at 22° C. and 50% relative humidity and a water vapor permeability of less than about 1.2 g/100 in² over 24 hours at 38° C. and 90% relative humidity; and
a functional layer comprising a thermoplastic adhesive and a release agent disposed on at least a portion of the barrier substrate.

2. The plastic laminate of claim 1, wherein the thermoplastic adhesive is provided in the form of an adhesive layer and the release agent is provided in the form of a release layer.

3. The plastic laminate of claim 2, wherein a the adhesive layer is disposed on the barrier substrate and the release layer is disposed on the adhesive layer.

4. The plastic laminate of claim 3, wherein the release layer is not disposed on a portion of the adhesive layer.

5. The plastic laminate of claim 1, wherein the barrier substrate comprises a sealing portion and a tab portion extending way from the sealing portion; and wherein the sealing portion is substantially free of the release agent.

6. The plastic laminate of claim 1, wherein the functional layer comprises an admixture of the thermoplastic adhesive and the release agent.

7. The plastic laminate of claim 1, wherein the functional layer further comprises a filler layer.

8. The plastic laminate of claim 1, wherein the barrier substrate has a thickness in a range of about 0.0025 mm to about 0.125 mm.

9. The plastic laminate of claim 8, wherein the barrier substrate has a thickness in a range of about 0.0127 mm to about 0.076 mm.

10. The plastic laminate of claim 1, wherein the barrier substrate comprises a material selected from the group consisting of polyethylene terephthalate, polypropylene, polystyrene, polyester, and mixtures thereof.

11. The plastic laminate of claim 1, wherein the thermoplastic adhesive comprises a material selected from the group consisting of polyvinyl acetate (PVA), polyvinyl alcohol (PVA), polyacrylate, polyester acrylic resin, silicone resin, polyamine, and mixtures thereof.

12. The plastic laminate of claim 1, wherein the thermoplastic adhesive has a glass-transition temperature below about 200° C.

13. The plastic laminate of claim 1, wherein the release agent comprises a high temperature wax, a silicone, an organopolysiloxane, a silicone and siloxane copolymer, a silicon and siloxane blend, an alkyacrylate-acrylic acid copolymer, a stearyl methylacrylate-acrylonitrile copolymer, a polystyrene copolymer, a strearic acid polyester-fomaldehyde resin, a fluorocarbon polymer, and mixtures thereof.

14. A method of manufacturing a plastic laminate, the method comprising:
binding a functional layer to a barrier substrate; wherein the functional layer comprises a thermoplastic adhesive and a release agent; wherein the barrier substrate has an oxygen permeability of less than about 5 mL over 24 hours at 22° C. and 50% relative humidity and a water vapor permeability of less than about 1.2 q/100 in² over 24 hours at 38° C. and 90% relative humidity; and wherein the barrier substrate has a thickness in a range of about 0.0025 mm to about 0.125 mm and comprises a polyethylene terephthalate.

15. The method of claim 14, wherein the barrier substrate has a thickness in a range of about 0.0127 mm to about 0.076 mm.

16. The method of claim 14, wherein the functional layer is bound to the barrier substrate by applying the thermoplastic adhesive to the barrier substrate and then applying the release agent to the thermoplastic adhesive.

17. A food container lid comprising the plastic laminate of claim 1, the plastic laminate further comprising a body portion, a symmetrically shaped sealing portion, and a tab portion extending outwardly from the edge of the body portion.

18. The food container lid of claim 17, wherein the body portion, the sealing portion, and the tab portion combine to be tear-drop shaped.

19. A method of closing a food container comprising:
adhering the plastic laminate of claim 1 to a rim of the food container, wherein the plastic laminate further comprises a tab portion and the plastic laminate is bound to the rim of the food container such that the tab portion of the plastic laminate extends from the rim of the food container.

20. The method of claim 33, wherein the barrier substrate has a thickness in a range of about 0.0127 mm to about 0.076 mm.

21. The method of claim 19, wherein adhering the plastic laminate to the rim of the food containing comprises:
positioning the plastic laminate adjacent to the rim of the food container;
applying a compressive force to the plastic laminate;
applying heat to the plastic laminate sufficient to cause at least a portion of the thermoplastic adhesive to soften.

22. The method of claim 19, further comprising:
displacing a portion of the release agent from an area defined by the rim of the container thereby causing the rim of the container to contact the thermoplastic adhesive and bind thereto.

23. A sealed food container comprising:
a food product;
a plastic container containing the food product; and
the plastic laminate of claim 1 adhered to and closing the plastic container.

24. The sealed food container of claim 34, wherein the barrier substrate has a thickness in a range of about 0.0127 mm to about 0.076 mm.

25. The sealed food container of claim 23, wherein the plastic laminate comprises a plastic laminate removal tab that extends from the plastic container for grasping by a user.

26. A bundle comprising a plurality of the sealed food containers of claim 22 collectively wrapped with a heat shrinkable wrapping.

27. The bundle of sealed food containers of claim 26, wherein less than 5%, of the sealed food containers in contact with the wrapping are damaged upon removal of the wrapping.

28. The bundle of sealed food containers of claim 27, wherein less than 2.5% of the sealed food containers in contact with the wrapping are damaged upon removal of the wrapping.

29. The bundle of sealed food containers of claim 27, wherein none of the sealed food containers in contact with the wrapping are damaged upon removal of the wrapping.

30. The plastic laminate of claim 11, wherein the thermoplastic adhesive comprises poly(methyl methacrylate) (PMMA)

31. The plastic laminate of claim 11, wherein the thermoplastic adhesive comprises a mixture of polyethylmethacrylate and a high density polyethylene.

32. The plastic laminate of claim 11, wherein the thermoplastic adhesive comprises a coextrusion of the polyethylmethacrylate and high density polyethylene.

33. The sealed food container of claim 19, wherein the barrier substrate has a thickness in a range of about 0.0025 mm to about 0.125 mm.

34. The sealed food container of claim 22, wherein the barrier substrate has a thickness in a range of about 0.0025 mm to about 0.125 mm.
